(19) United States
(12) Patent Application Publication
(10) Pub. No.: US 2019/0032412 A1
(43) Pub. Date: Jan. 31, 2019

(54) AUGER MEMBER

(71) Applicant: Daniel Banjo, Boulder, CO (US)

(72) Inventor: Daniel Banjo, Boulder, CO (US)

(21) Appl. No.: 16/023,214

(22) Filed: Jun. 29, 2018

Related U.S. Application Data
(60) Provisional application No. 62/526,719, filed on Jun. 29, 2017.

(51) Int. Cl. E21B 10/44; E21B 7/00

(52) U.S. Cl. CPC E21B 10/44; A01K 97/01; E21B 7/008

(57) ABSTRACT

An improved cutting auger bit and auger are provided. The auger bit comprises a geometry and structure formed with a high degree of precision and tolerances that reduce oscillations and vibrations resulting from rotation of the bit. The bit further comprises a structure with a center of mass corresponding to an axial centerline of a drive shaft to which the auger is to be provided.

This U.S. Non-Provisional patent application claims the benefit of priority from U.S. Provisional Patent Application Ser. No. 62/526,719, filed Jun. 29, 2017, the entire disclosure of which is hereby incorporated by reference in its entirety.

### FIELD

The present disclosure relates generally to cutting augers. More specifically, embodiments of the present disclosure relate to bits for use with cutting augers including, but not limited to, ice augers.

### BACKGROUND

Cutting augers are known to provide an efficient cutting and boring means for forming holes. Such augers generally comprise rotational devices having one or more blades and helical fighting to bore into and remove material from soil, ice, etc. and comprise a power source such as an internal combustion engine or an electric motor.

Existing auger devices suffer from various drawbacks including, for example, the generation of significant amounts of vibration due to asymmetries of the devices, inadequate connections means of various device components, and the structure of a distal or cutting end of the device. Vibration and asymmetries of such devices serve to reduce cutting efficiency and create a device that is difficult or uncomfortable for a user to handle. Existing devices and methods generally fail to address these issues, with the possible exception of simply providing a device with sufficient power to overcome decreased efficiencies. Such devices provide a crude, inefficient, and ineffective solution and are particularly undesirable when cutting through a relatively smooth and homogenous medium such as ice, for example.

### SUMMARY

Accordingly, there has been a long-felt and unmet need to provide an improved cutting auger. Embodiments of the present disclosure provide a cutting auger and associated bit that are operable to and suitable for cutting ice. It will be recognized, however, that devices of the present disclosure are not limited to ice augers. Devices as shown and described herein may be used for various applications and methods including, but not limited to, forming holes in ice, soil, concrete, and wood. In various embodiments, devices of the present disclosure are sized such that they are operable to form holes in an ice sheet, such as may be useful for forming an ice fishing hole. However, the present disclosure is not limited to these intended uses and methods. Devices of the present disclosure are contemplated as being useful for cutting holes or recesses in various materials of various sizes. For example, in some embodiments, devices of the present disclosure are dimensioned and provided such that they are useful for woodworking.

In various embodiments, a cutting auger bit is provided that comprises a die-cast material. In preferred embodiments, at least a portion of an auger bit comprises die-cast aluminum. Such embodiments contemplate the provision of an aluminum material as such materials comprise a sufficient hardness to cut ice and also comprise a relatively low weight per unit area and thus reduce angular momentum when provided on a rotational device.

In various embodiments, the present disclosure provides an ice auger bit comprising a rotational symmetry, wherein the bit comprises a low degree of eccentricity and therefore produces a reduced or minimal amount of vibration during operation. Cutting efficiency is thereby improved. In some embodiments, ice augers are provided with an electric motor. The power-demand of the electric motor is reduced at least in part by an increased cutting efficiency of a bit, and overall size, weight and cost of an ice auger device is thereby reduced.

In various embodiments, a cutting auger bit is provided that is selectively securable to a drive shaft of an auger device. The bit comprises an extension that is securable to a drive shaft with at least one fastener (e.g. bolt and/or nut). In preferred embodiments, the extension comprises a male extension that is received within a female receiving portion of a shaft. It is also completed, however that the bit comprises a female portion within which the shaft is received and secured. Preferably, the extension of the bit and the shaft are secured together such that the extension and the shaft are substantially coaxially mounted. The bit further comprises a circular ring and at least two blade-mounting portions to which cutting blades may be secured. In preferred embodiments, cutting blades are selectively secured to the bit by fasteners such that they may be removed for servicing, sharpening, or replacement. In alternative embodiments, the cutting blades are permanently mounted to or co-formed with the bit.

Cutting auger bits of the present disclosure are contemplated for use with an auger element comprising a shaft and helical flighting. Auger bits of the present disclosure are contemplated as comprising an attachment and/or support member for flighting. In such embodiments, an opposing member is provided to create rotational symmetry and such that the attachment or support member for the fighting does not comprise an asymmetrical feature.

In one embodiment, an auger bit is provided wherein the auger bit comprises a substantially circular cutting ring defining an outer perimeter of the bit, a center support provided at a midpoint of the substantially circular cutting ring, a first blade mounting member and a second blade mounting member extending between the center support and the substantially circular cutting ring, wherein the first blade mounting member and the second blade mounting member are positioned approximately 180 degrees from one another. A male extension extends from the center support, and the male extension is operable to connect the bit to a drive shaft. A fighting rest extends between the center support and the substantially circular cutting ring, wherein the fighting rest is offset from the first blade mounting member and the second blade mounting member.

In some embodiments, a method of forming an auger bit is provided. The methods comprise die-casting an auger bit, wherein the auger bit comprises a cutting ring, at least one blade attachment member, and a center support and wherein the bit is devoid of weldments. In various embodiments, auger bits of the present disclosure are formed of die-cast aluminum. Embodiments of the present disclosure provide for a novel bit structure that provides various advantages in the drilling and forming of apertures (in an ice sheet, for example), and wherein the bit can be formed from a die-casting operation such that the bit comprises a device of unitary construction and does not require welding to form the bit. In one embodiment, a method of forming an auger bit is provided, the method comprising: providing a mold cavity comprising a substantially circular cutting ring; a center support provided at a midpoint of the substantially circular cutting ring; a first blade mounting member and a second blade mounting member extending between the center support and the substantially circular cutting ring, wherein the first blade mounting member and the second blade mounting member are positioned approximately 180 degrees from one another; a male extension extending from the center support, the male extension operable to connect the bit to a drive shaft; and a fighting rest extending between the center support and the substantially circular cutting ring, wherein the fighting rest is offset from the first blade mounting member and the second blade mounting member, and providing a quantity of material to the mold cavity to form an auger bit. In some embodiments, the material comprises an aluminum.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosure.

FIG. 1 is a perspective view of a cutting auger according to one embodiment of the present disclosure.

FIG. 2 is a perspective view of a cutting auger according to one embodiment of the present disclosure.

FIG. 3 is a side elevation view of the cutting auger according to the embodiment of FIG. 2.

FIG. 4 is a top perspective view of a cutting auger bit according to one embodiment of the present disclosure.

FIG. 5 is a bottom perspective view of the cutting auger bit according to the embodiment of FIG. 4.

FIG. 6 is a perspective view of a cutting auger according to one embodiment of the present disclosure.

FIG. 7 is a front elevation view of a portion cutting auger according to one embodiment of the present disclosure.

FIG. 8 is a perspective view of a portion of a cutting auger according to the embodiment of FIG. 7.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

### DETAILED DESCRIPTION

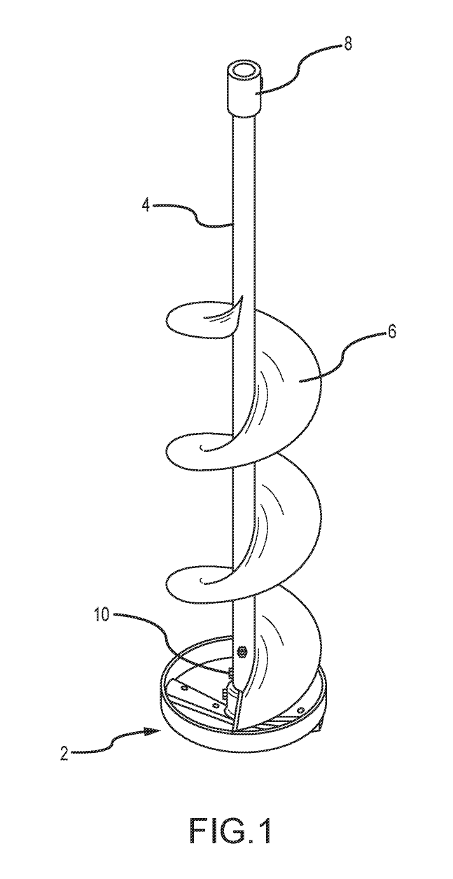

FIG. 1 is a perspective view of a cutting auger device according to one embodiment of the present disclosure. As shown, the cutting auger comprises a bit 2 provided on a distal end of a shaft 4. The shaft 4 comprises helical flighting 6 that extends along at least a portion of the shaft 4 and is secured to or proximal to the bit 2. A proximal end of the shaft 4 comprises an attachment member 8 for receiving and connecting to a power source (not shown in FIG. 1). Power sources for use with cutting augers of the present disclosure include, but are not limited to, internal combustion engines, electric motors, and hand cranks. As shown in FIG. 1, the bit 2 comprises at least one cutting surface for cutting material, such as ice. The flighting 6 is provided to convey cut or dislodged material away from the bit as will be recognized by one of ordinary skill in the art. In the embodiment of FIG. 1, the flighting 6 extends along approximately two-thirds of the length of the shaft. However, no limitation with respect to the dimensions of the fighting is provided herewith.

The bit 2 of FIG. 1 is connected to the shaft 4 at a connection point 10. In the depicted embodiment, the connection point 10 comprises a male extension of the bit inserted into a female portion of the shaft 4. The bit and the shaft are secured by at least one fastener that extends at least partially through both the bit 2 and the shaft 4, and wherein the male extension of the bit 2 and the shaft 4 are positioned substantially coaxially.

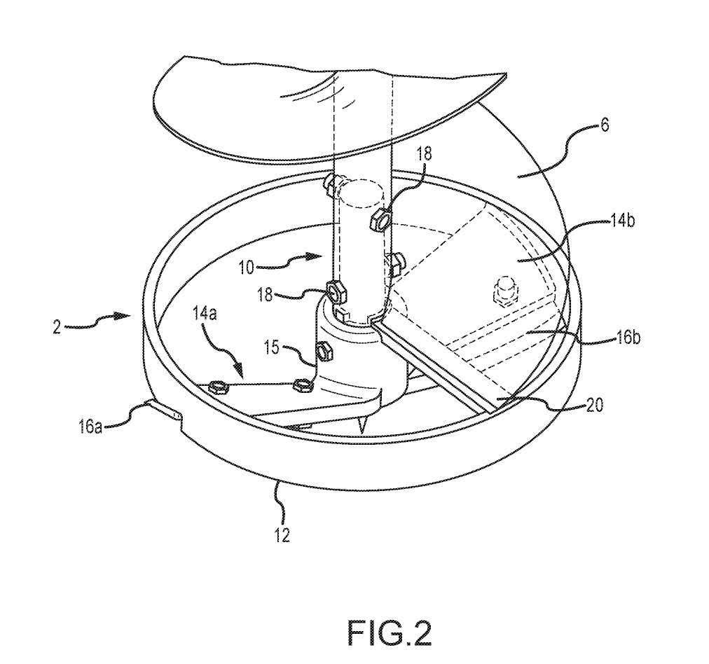

FIG. 2 is a detailed perspective view of a bit 2 according to one embodiment of the present disclosure. As shown, the bit 2 comprises a circular cutting ring 12. In various embodiments, the cutting ring 12 comprises a support feature for blade mounting members and generally defines a circumference of a hole or aperture to be formed by the bit 2. In preferred embodiments, the cutting ring 12 does not comprise a sharpened cutting surface. In alternative embodiments, however, it is contemplated that the cutting ring 12 comprises a sharpened, serrated, and/or rasped bottom edge. First and second blade mounting members 14a, 14b are provided and extend between a center support 15 and the cutting ring 12. The blade mounting members 14a, 14b are provided to selectively secure cutting blades, which are provided connected to the bit 2 by one or more fasteners. A flighting rest 20 is provided that extends between the cutting ring 12 and the center support 15. The fighting rest comprises a notched member that receives and supports a fighting member 6 as shown. In preferred embodiments, the bit 2 including the cutting ring 12, the blade mounting members 14a, 14b, the center support 15 and the flighting rest 20 comprise a single die-cast structure. Specifically, and in at least some embodiments, the bit 2 comprises a die-cast aluminum member that is molded or cast as a single component which comprises a high degree of rotational symmetry and wherein vibrations and oscillations caused by rotation of the bit 2 are minimized.

The bit 2 is also preferably devoid of weldments, and construction and manufacturing of the bit is simplified into a die-casting process. Manufacturing efficiencies and decreased waste in the manufacturing process are thereby accomplished. Die-casting processes of the present disclosure provide a high-tolerance and high-precision product to be produced, ensuring a high-degree of concentricity and rotational symmetry. Symmetrical bits of the present disclosure are particularly useful in combination with electric motor-driven augers. Such bits reduce vibration and thereby reduce a power-demand on the motor, as well as reducing the risk that the motor is overloaded. As one of ordinary skill in the art will recognize, asymmetries and vibrations in the bit will cause reduced cutting efficiency and increase the power demand from a power source that is required to provide appropriate torque on the shaft. Improved efficiencies are accomplished by devices of the present disclosure, which reduces a required power or current that is required to be supplied.

In certain embodiments, die-cast bits of the present disclosure are provided with a consistent and preferred drilling angle for blades. Bits produced from the same die-cast mold consistently produce blade mounting members 14a, 14b of a predetermined angle, and ensure proper alignment and positioning of cutting blades. Devices and methods of the present disclosure also provide for little or no variation in the mounting position of cutting blades relative to a drive shaft.

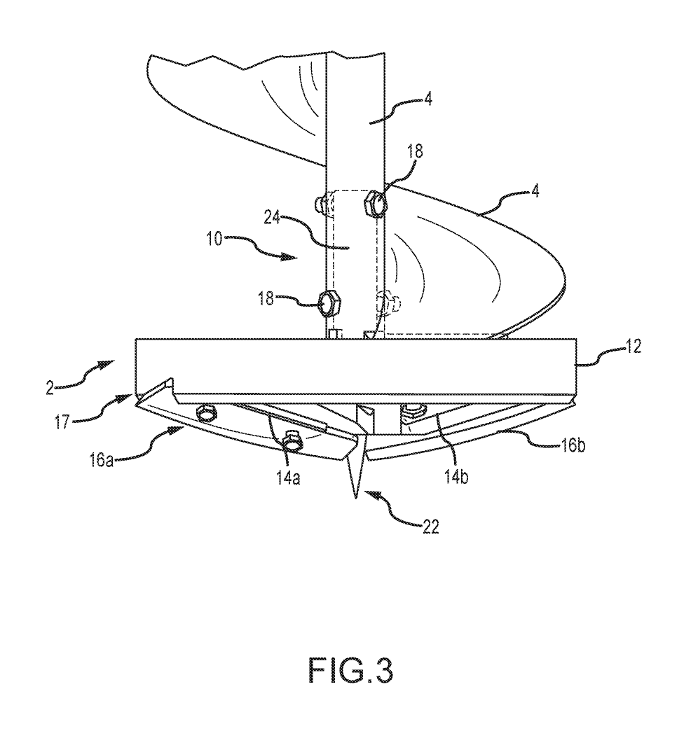

FIG. 3 is a side elevation view of the bit 2 according to the embodiment of FIG. 2, and wherein the bit is attached to a drive shaft 4 and provided with cutting blades 16a, 16b. As shown, the bit 2 comprises a male extension 24 for aligning and mounting the bit 2 with the shaft 4. The male extension 24 is provided within the drive shaft 4 and secured thereto by first and second fasteners 18 as shown in FIG. 3. The male extension 24 and a female portion in the shaft 4 comprise a tight tolerance wherein the male extension of the bit 2 and the drive shaft are provided coaxially, such that a center of mass of the bit 2 is closely aligned with a longitudinal axial centerline of the shaft 4.

In various embodiments, auger bits of the present disclosure comprise a male extension on the bit that extends into and is received by a female portion of a drive shaft. However, various alternative arrangements for this connection are contemplated. For example, the bit may comprise a female portion at a midpoint of the cutting ring of the bit that receives the drive shaft and wherein the drive shaft itself comprises the male connecting member. Additionally, a male extension of the bit may extend upwardly from the bit and comprise an open center area that serves as a female receiving portion for a drive shaft. Various arrangements for this connection are contemplated wherein the bit and the driveshaft are mounted substantially coaxially, and the present disclosure is not limited to the depicted embodiments.

As shown in FIG. 3, first and second fasteners 18 comprises threaded bolts and nuts are provided to secure the bit 2 and the shaft 4. Devices of the present disclosure are contemplated as comprising as few as one fastener to connect the bit 2 to the shaft 4. In preferred embodiments, however, a plurality of fasteners is provided to provide greater shear resistance and reduce movement between the components 2, 4.

As shown in FIG. 3, first and second cutting blades 16a, 16b are provided on the bit and are secured to the blade mounting members 14a, 14b with fasteners. A notch 17 is provided for each of the blades 16, and ensures a proper mounting angle of the blades relative to the cutting ring 12. A cutting tip 22 is further provided to initiate and guide a cutting operation. In various embodiments, the cutting tip 22 is mounted by inserting the tip 22 into the bit 2 with a molded clamp piece, and the tip 22 is then bolted to the bit 2.

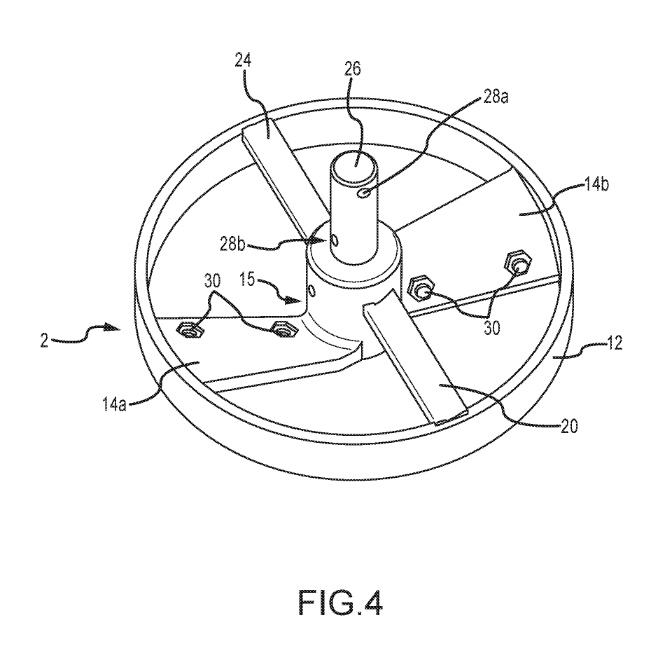

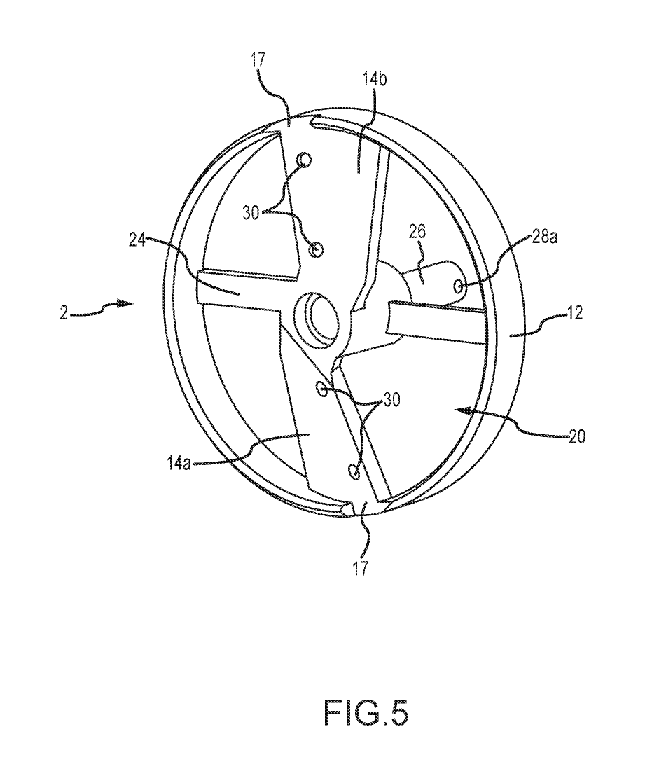

FIGS. 4-5 are top and bottom perspective views of an auger bit 2 according to one embodiment of the present disclosure. As shown, the bit comprises a cutting ring 12 and a center support 15 provided at a center of the cutting ring 12. A pair of blade mounting members 14a, 14b extend between the cutting ring 12 and the center support 15. A male extension 26 extends from the center support and provides a mounting means for securing the bit to a drive shaft (not shown in FIG. 4). At least one fighting rest 20 is provided. A connecting member 24 is further provided and extends between the cutting ring 12 and the center support 15. In some embodiments, the connecting member 24 is provided to balance and offset the mass of the fighting rest 20. In preferred embodiments, the bit 2 comprises a center of mass that is aligned with an axial centerline of the male extension 26, which is also the center point of the cutting ring 12. The bit 2 therefore comprises a center of mass that is operable to align with a centerline of a drive shaft, creating a rotationally stable object that reduces eccentricity, oscillations, and vibrations during operation and increases cutting efficiency while reducing a power demand on an engine, motor, or other power source.

As shown in FIG. 4, the male extension 26 of the bit 2 comprises first and second through-holes 28a, 28b for mounting the bit to a drive shaft. The pair of through-holes 28a, 28b provide for a secure interconnection between the bit 2 and a shaft, and help to maintain a center of mass of the assembled device at or proximal to a centerline of the bit and shaft. The first and second apertures 28a, 28b are preferably provided at approximately 90 degrees to one another.

The blade mounting members 14a, 14b are provided with apertures 30 for receiving fasteners to secure blades. The apertures 30 may be formed after die-casting or may be produced during the die-casting operation.

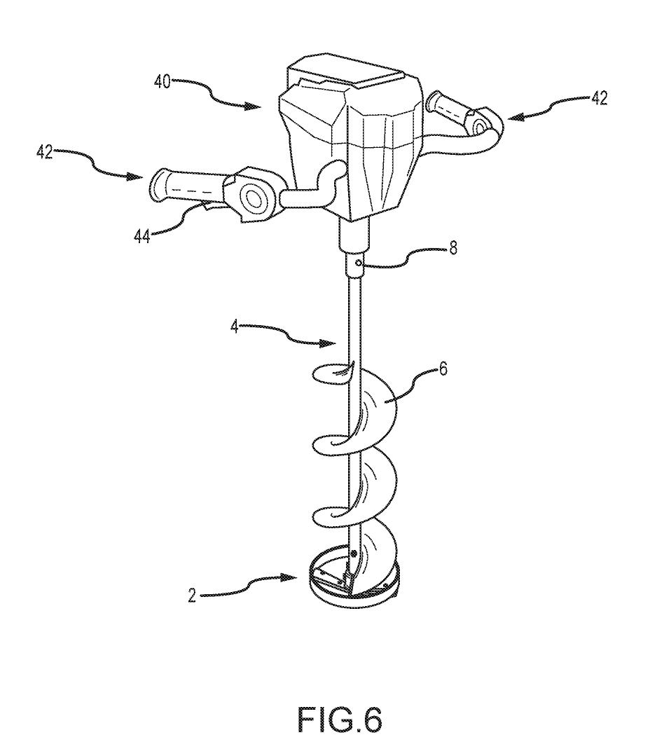

FIG. 6 is a perspective view of a cutting auger according to one embodiment of the present disclosure. As shown, the auger comprises various features already shown and described herein, including a bit, a drive shaft 4 with fighting 6, and an attachment member 8 for receiving a power source 40. In the depicted embodiment, the power source 40 comprises an electric motor with a user-interface that comprises a pair of handles 42 and a trigger 44 to activate the motor. FIG. 6 illustrates one cutting auger that is contemplated for use with bits 2 as shown and described herein. However, bits 2 and various novel features thereof may be provided in combination with various different auger devices and power sources.

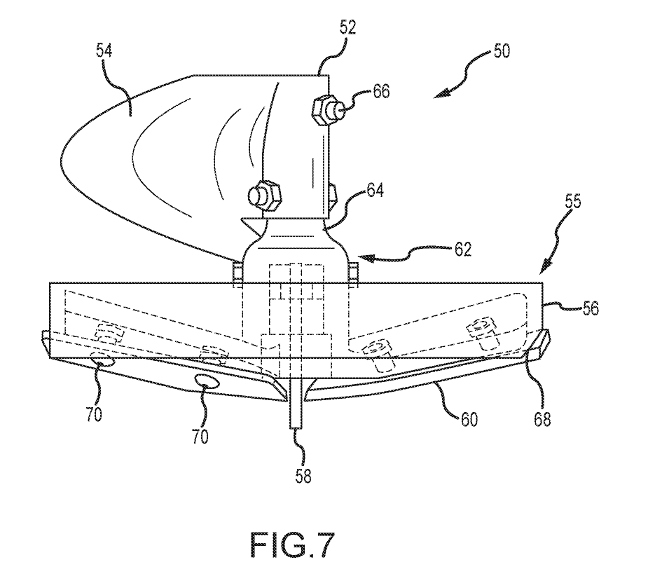

FIG. 7 is a side elevation view of an auger member comprising a drive shaft 52 with fighting 54. An auger head or bit 55 is secured to the drive shaft 52. The bit 55 is provided with cutting blades 60. As shown, the bit 55 comprises a male extension for aligning and mounting the bit 55 with the shaft 52. The male extension 62 comprises a first diameter that narrows or reduced to a second diameter via a fillet 64, and the first diameter fits within an internal diameter of the drive shaft 52. The bit 55 is secured to the drive shaft by fasteners 66. The male portion of the bit preferably fits within the drive shaft 52 and comprises a tight tolerance wherein the male extension of the bit and the drive shaft are provided coaxially, such that a center of mass of the bit 55 is closely aligned with a longitudinal axial centerline of the shaft 52.

As is further shown in FIG. 7, a pair of cutting blades 60 are provided and are secured to the bit body by fasteners 70. Receiving portions 68 are provided in the bit 55 to receive and support at least a portion of the blades. A pilot member 58 is provided that extends from the bit 55 and preferably comprises a point or tip that is substantially aligned with a longitudinal axis of the drive shaft 52.

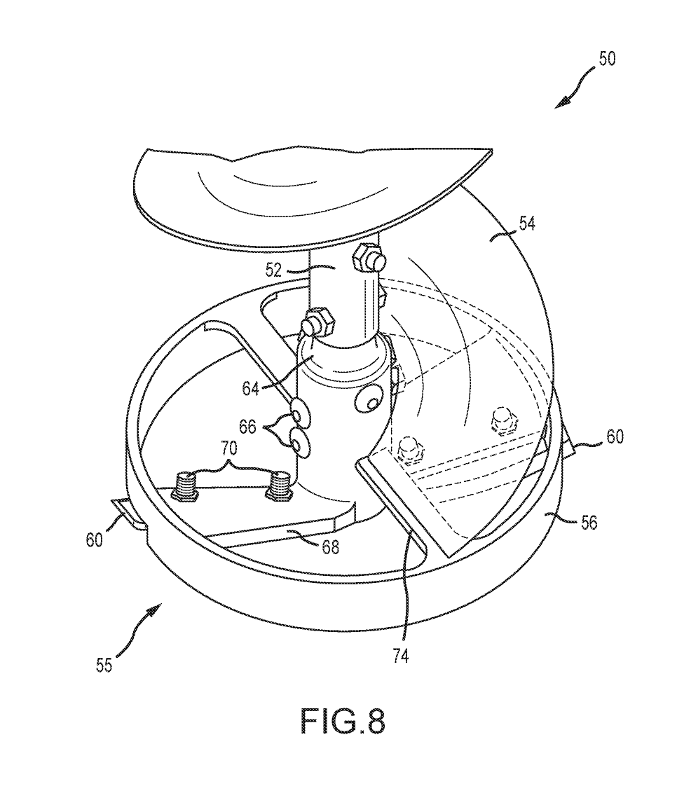

FIG. 8 is a top perspective view of the cutting auger of FIG. 7. As shown, a bit 55 is secured to the drive shaft 52. As shown in FIG. 8, the bit 55 comprises a flighting rest 74 for receiving a fighting 54 of an auger. A portion of the flighting 54 is shown in phantom in FIG. 8 for illustrative purposes. The flighting rest 74 comprises a portion of the bit that is, in some embodiments, cast or co-formed with the remainder of the bit and comprises an integral component of the bit. The fighting rest 74 serves as a support for the fighting and provides a means for alignment, positioning, and securement of the bit 55 and the shaft 52. In some embodiments, the fighting rest 74 comprises a notch or V-shaped cross section to receive and secure a distal end of the flighting 54 of an auger. The bit 55 further comprises a radial support member 75. In some embodiments, the radial support member 75 is provided to give structural support to the bit and comprises a substantially rectangular cross section. In other embodiments, the radial support member 75 comprises a secondary flighting rest that is of similar construction and cross-section to the first fighting rest 74.

While various embodiments of the present disclosure have been described in detail, it is apparent that modifications and alterations of those embodiments will occur to those skilled in the art. However, it is to be expressly understood that such modifications and alterations are within the scope and spirit of the present disclosure. Further, the invention(s) described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. A bit for an ice auger, the bit comprising:
a substantially circular cutting ring;
a center support provided at a midpoint of the substantially circular cutting ring;
a first blade mounting member and a second blade mounting member extending between the center support and the substantially circular cutting ring, wherein the first blade mounting member and the second blade mounting member are positioned approximately 180 degrees from one another;
a male extension extending from the center support, the male extension operable to connect the bit to a drive shaft;
a flighting rest extending between the center support and the substantially circular cutting ring, wherein the fighting rest is offset from the first blade mounting member and the second blade mounting member.

2. The bit of claim 1, wherein the bit comprises a single piece of material formed in a die-cast mold.

3. The bit of claim 2, wherein the bit comprises aluminum.

4. The bit of claim 1, wherein the bit comprises a center of mass that is positioned at a geometric center of the male extension and at the midpoint of the substantially circular cutting ring.

5. The bit of claim 1, further comprising a drive shaft connected to the male extension and secured by at least one fastener.

6. The bit of claim 1, wherein a cutting blade is secured to at least one of the first blade mounting member and the second blade mounting member, and wherein the cutting blade is secured by at least one bolt.

7. The bit of claim 1, further comprising a cutting tip extending vertically below the cutting ring and the blade mounting members.

8. An auger bit comprising:
a substantially circular ring;
a center support;
a first blade mounting member and a second blade mounting member extending between the center support and the substantially circular cutting ring, wherein the first blade mounting member and the second blade mounting member are positioned approximately 180 degrees from one another;
the center support operable to selectively connect the auger bit to a drive shaft;
a flighting rest extending between the center support and the substantially circular cutting ring, wherein the fighting rest is offset from the first blade mounting member and the second blade mounting member and is operable to align the auger bit with a drive shaft and associated flighting.

9. The auger bit of claim 8, wherein the bit comprises a single piece of material formed in a die-cast mold.

10. The auger bit of claim 9, wherein the bit comprises aluminum.

11. The auger bit of claim 8, wherein the bit comprises a center of mass that is positioned at a geometric center of the male extension and at the midpoint of the substantially circular cutting ring.

12. The auger bit of claim 8, further comprising a drive shaft connected to the male extension and secured by at least one fastener.

13. The auger bit of claim 8, wherein a cutting blade is secured to at least one of the first blade mounting member and the second blade mounting member, and wherein the cutting blade is secured by at least one bolt.

14. The auger bit of claim 8, further comprising a cutting tip extending vertically below the cutting ring and the blade mounting members.

15. An auger adapted for cutting circular holes in an ice sheet, the auger comprising:
an auger bit comprising a substantially circular ring, a center support, at least one blade mounting member extending between the center support and the substantially circular cutting ring, wherein the at least one blade mounting member is operable to selectively receive a cutting blade, and a male extension;
a drive shaft comprising a first end and a second end and a predetermined length extending therebetween;
the first end of the drive shaft being secured to the auger bit;
the second end of the drive shaft comprising an attachment member for receiving and connecting to a power source;
the drive shaft further comprising a helical fighting extending along at least a portion of the predetermined length; and
a power source connected to the attachment member of the drive shaft, and wherein the power source is operable to apply a torque to the drive shaft.

16. The auger of claim 15, wherein the auger further comprises a pair of handles operable to be grasped by a user.

17. The auger of claim 15, wherein the power source comprises an electric motor.

18. The auger of claim 15, further comprising at least one cutting blade secured to the auger bit.

19. The auger of claim 16, wherein at least one of the handles comprises a trigger member to operate the power source.

20. The auger of claim 15, wherein the auger bit is secured to the drive shaft by at least one bolt.
